(19) United States
(12) Patent Application Publication
(10) Pub. No.: US 2022/0298055 A1
(43) Pub. Date: Sep. 22, 2022

(54) DISPLAY COMPOSITIONS CONTAINING PHOSPHOROUS AND LOW IONIC FIELD STRENGTH MODIFIERS

(71) Applicant: CORNING INCORPORATED, CORNING, NY (US)

(72) Inventors: Timothy Michael Gross, Painted Post, NY (US); Alexandra Lai Ching Kao Andrews Mitchell, Ithaca, NY (US)

(21) Appl. No.: 17/616,727

(22) PCT Filed: Jun. 3, 2020
(86) PCT No.: PCT/US2020/035807

§ 371 Date: Dec. 6, 2021

Related U.S. Application Data
(60) Provisional application No. 62/861,095, filed on Jun. 13, 2019.

(51) Int. Cl. C03C 3/087; C03C 3/097; C03C 3/093; C03C 3/085

(52) U.S. Cl. CPC C03C 3/087; C03C 3/097; C03C 3/093; C03C 3/085

(57) ABSTRACT

A glass composition and substrate are provided. The glass substrate can include about 50 to about 80 mole percent of SiO₂; about 1 to about 30 mole percent of Al₂O₃; 0 to about 30 mole percent of B₂O₃; about 1.0 to about 10.1 mole percent of P₂O₅; and about 10.5 to about 15.7 mole percent of SrO, BaO, K₂O, or a combination thereof, and wherein the composition includes less than about 5 mole percent of ZnO, MgO, CaO, or a combination thereof. A device incorporating the glass substrate is also provided.

### CROSS-REFERENCE TO RELATED APPLICATION

This application claims the benefit of priority under 35 U.S.C. § 119 of U.S. Provisional Application Ser. No. 62/861,095 filed on Jun. 13, 2019, the content of which is relied upon and incorporated herein by reference in its entirety.

### BACKGROUND

The disclosure relates generally to a glass composition, and more particularly, to a glass substrate for display applications, such as devices with a thin-film transistor (TFT) or organic light-emitting diode (OLED).

As electronic devices continue to get smaller and more complex, requirements for glass substrates used in the manufacture of display panels are becoming more stringent. For instance, smaller and thinner glass substrates can have a lower tolerance for dimensional variations of the glass substrates. Similarly, tolerances for variations in glass substrate properties, e.g., strength, density, and elasticity, can also diminish. The dimensions and properties of a particular glass substrate composition generally depend on its thermal history. For example, glass prepared by quenching at a fast rate can have a relatively more open structure than one prepared at a slower rate or annealed near its glass transition temperature. Having a loosely-packed, open structure can allow the glass to accommodate small-scale structural changes over a range of temperatures without affecting its global structure. In other words, the properties of the glass are less dependent on temperature. By contrast, glass having a less open structure, including glass with localized crystalline structures, may be less capable of accommodating structural changes over a range of temperatures. As a result, a particular glass may meet the specifications for electronic devices before cooling or finishing, but fail to meet the specifications after cooling or subsequent processing. Accordingly, a need exists for glass compositions that are adequate substrates for display applications.

### SUMMARY

In various embodiments, a glass substrate is provided. The glass substrate can include, in mole percent: about 40 to about 80 percent SiO₂; about 1 to about 30 percent Al₂O₃; 0 to about 30 percent B₂O₃; about 1.0 to about 10.1 percent P₂O₅; and about 10.5 to about 15.7 percent of SrO, BaO, K₂O, or a combination thereof. In such embodiments, the glass substrate can include less than 5 percent of ZnO, MgO, CaO, or a combination thereof.

In various embodiments, a device incorporating the glass substrate is provided.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1A depicts a graph showing the fictive temperature (T_{f}) for normal glass.

FIG. 1B depicts a graph showing the fictive temperature (T_{f}) for anomalous glass.

### DETAILED DESCRIPTION

Reference will now be made in detail to the present preferred embodiment(s), an example of which is/are illustrated in the accompanying drawings. Whenever possible, the same reference numerals will be used throughout the drawings to refer to the same or like parts.

Unless defined otherwise, all technical and scientific terms used herein have the same meaning as commonly understood by those of ordinary skill in the art to which this application belongs. Although any methods and materials similar or equivalent to those described herein can be used in the practice or testing of embodiments of the present application, the preferred methods and materials are described. Generally, nomenclatures utilized in connection with, and techniques of chemistry are those known and commonly used in the art. Certain experimental techniques, not specifically defined, are generally performed according to conventional methods known in the art and as described in various general and more specific references that are cited and discussed throughout the present specification.

In the present disclosure the singular forms “a,” “an,” and “the” include the plural reference, and reference to a particular numerical value includes at least that particular value, unless the context clearly indicates otherwise. The terms “substantial,” “substantially,” and variations thereof as used herein are intended to note that a described feature is equal or approximately equal to a value or description. When values are expressed as approximations, by use of the antecedent “about,” it will be understood that the particular value forms another embodiment. Where recited, all ranges are inclusive and combinable.

The terms “free” and “substantially free,” when used to describe the concentration and/or absence of a particular component in a glass composition, means that the component was not intentionally added to the glass raw materials or composition. However, if present, the content of the component in the composition reaches only the level of an impurity unavoidably included in the process. For example, the glass composition may contain traces of the component as a contaminant or tramp in amounts of less than about 0.1 mole percent (mol %), less than 0.05 mol %, less than 0.03 mol %, less than 0.01 mol %, etc.

The liquidus temperature of a glass (T_{liq}) is the temperature (° C.) above which no crystalline phases can coexist in equilibrium with the glass. The liquidus viscosity is the viscosity of a glass at the liquidus temperature.

As used herein, field strength (F) is defined as valence of the cation (Z_{c}) divided by the squared sum of the cation radius (r_{c}) and anion radius (rₐ): F=Z_{c}/(r_{c}+rₐ)². In this context, a value of more than 1.3 is considered a high field strength, a value of less than 0.4 is considered a low field strength, and a value between 0.4 and 1.3 is considered intermediate field strength.

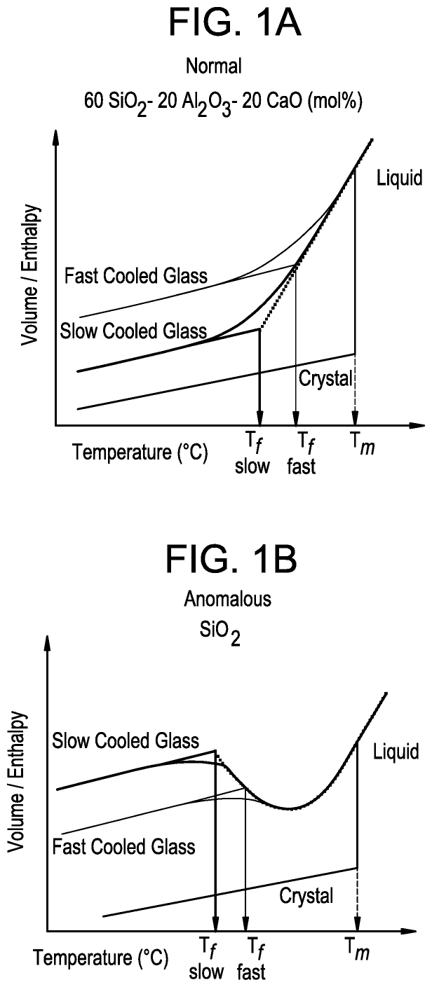

Fictive temperature (T_{f}) is a parameter effective for characterizing the structure and properties of a glass. For a given glass, the fictive temperature corresponds to the temperature (or temperature range) at which the glass would be in equilibrium if suddenly brought within that temperature range. The cooling rate from the melt affects the fictive temperature. For example, FIG. 1A depicts a graph showing the change in volume for “normal” glasses over a range of temperatures. The faster the cooling rate, the higher the fictive temperature. As shown in FIG. 1B, the opposite trend is observed for “anomalous” glasses, although only normal glasses are disclosed here. FIG. 1B shows that the slower the cooling rate, the lower the fictive temperature. For glasses characterized as “normal,” properties such as Young's modulus, shear modulus, refractive index, and density decrease with increasing fictive temperature. The rate of change in these properties with fictive temperature depends on glass composition. The fictive temperature of the glass can be set by holding the glass at a given temperature in the glass transition range. The minimum time required to reset the fictive temperature can be approximated by 30×((the viscosity of the glass at the heat treatment temperature)/shear modulus). To ensure full relaxation to the new fictive temperature, glasses may be held at times far exceeding 30×((the viscosity of the glass at the heat treatment temperature)/shear modulus).

The sensitivity of a glass to its thermal history may be measured by comparing the Young's modulus of the glass with the fictive temperature set to the annealing point temperature (referred to herein as the “first endpoint”) and the Young's modulus of the glass with the fictive temperature set to the strain point temperature (referred to herein as the “second endpoint”). Glasses with low sensitivity to their thermal history will have a Young's modulus at the first endpoint similar to the Young's modulus at the second endpoint, because this shows Young's modulus is not significantly affected by the thermal history of the glass. Thus, the sensitivity of the glass composition to its thermal history may be determined by the slope of a line between the first endpoint and the second endpoint. In such embodiments, the slope is defined as the change in Young's modulus E (gigaPascals, GPa) per 1° C. change in fictive temperature. Particularly, the closer the slope dE/dT_{f} of such a line gets to 0.0, the less sensitive the glass is to its thermal history. The value of the slope can be expressed as an absolute value. It does not matter whether the slope of a line extending between the first endpoint and the second endpoint is positive or negative. For example, when the Young's modulus of a glass is measured at the first endpoint and the second endpoint, and the slope of a line extending between the first endpoint and the second endpoint is 0.02, the sensitivity of the glass to its thermal history will be about the same as the sensitivity of a glass where the slope dE/dT_{f} of a line extending between the first endpoint and the second endpoint is −0.02. Thus, the slope of dE/dT_{f} of Young's modulus as a function of fictive temperature may be expressed as an absolute value and designated with bracketing vertical bars, e.g., |0.02|. For example, where a slope dE/dT_{f} is indicated as “equal to or less than |0.020|” the expression refers to the absolute value of the slope, such that a slope in the range from −0.020 to 0.020 is included.

Young's modulus is used as the first endpoint and the second endpoint to determine the sensitivity of a glass to its thermal history because Young's modulus can be measured with good accuracy. In some embodiments, the absolute value of the slope of a line extending between the first endpoint and the second endpoint is equal to or less than |0.022| GPa/° C., such as equal to or less than |0.020| GPa/° C., such as equal to or less than 0.019 GPa/° C., equal to or less than |0.018| GPa/° C., equal to or less than |0.017| GPa/° C., equal to or less than |0.016| GPa/° C., equal to or less than |0.015| GPa/° C., equal to or less than |0.014| GPa/° C., equal to or less than |0.013| GPa/° C., equal to or less than |0.012| GPa/° C., equal to or less than |0.011| GPa/° C., equal to or less than |0.010| GPa/° C., equal to or less than |0.009| GPa/° C., equal to or less than |0.008| GPa/° C., equal to or less than |0.007| GPa/° C., equal to or less than |0.006| GPa/° C., equal to or less than |0.005| GPa/° C., equal to or less than |0.004| GPa/° C., equal to or less than |0.003| GPa/° C., equal to or less than |0.002| GPa/° C., or equal to or less than |0.001| GPa/° C. In some embodiments, dE/dT_{f} can be in a range from about |0.001| GPa/° C. to about |0.022| GPa/° C., for example in a range from about |0.001| GPa/° C. to about |0.020| GPa/° C., such as in a range from about |0.002| GPa/° C. to about |0.019| GPa/° C., or in a range from about |0.002| GPa/° C. to about |0.018| GPa/° C. For each of the above values, the absolute value of the slope of a line extending between the first endpoint and the second endpoint is equal to or greater than |0.000|.

Without being bound by any particular theory, it is believed that glasses where an absolute value of the slope of a line extending between the first endpoint and the second endpoint is equal to or less than |0.022| GPa/° C. are particularly useful because the volume of such glasses do not change, or change very little, regardless of the manufacturing method and conditions used to manufacture the glass. It is believed, again without being bound by any particular theory, that glasses comprising high amounts of silica, and possibly other tetrahedral units, are likely to be insensitive to their thermal histories and may be more likely to have an absolute value of a slope of a line extending between the first endpoint and the second endpoint that is equal to or less than |0.022| GPa/° C.

Additionally, it was found that glass compositions having about 1.0 to about 10.1 mole percent of phosphorus pentoxide (P₂O₅) and about 10.5 to about 15.7 mole percent of the low field strength modifiers SrO, BaO, K₂O, or a combination thereof, results in a reduction in dE/dT_{f}. It was found that the presence of the low field strength modifiers also correlated with reducing the slope of Young's modulus, and further that low field strength modifiers can provide lower Young's modulus slopes than high field strength modifiers. Glass compositions that meet these requirements are described below.

In various embodiments, the glass compositions have a density, regardless of fictive temperature, in a range from about 2.00 g/cm³ to about 3.30 g/cm³, such as in a range from about 2.25 g/cm³ to about 3.10 g/cm³, in a range from about 2.40 g/cm³ to about 2.90 g/cm³, including all ranges and sub-ranges between the foregoing values. The density values recited in this disclosure refer to a value as measured by the buoyancy method of ASTM C693-93(2013).

In various embodiments, the glass compositions have a Young's modulus, regardless of fictive temperature, in a range from about 50.0 GPa to about 80.0 GPa, such as in a range from about 55.0 GPa to about 78.0 GPa, in a range from about 59.0 GPa to about 74.0 GPa, including all ranges and sub-ranges between the foregoing values. The Young's modulus values recited in this disclosure refer to a value measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.”

In various embodiments, the glass compositions have a Poisson's ratio, regardless of fictive temperature, in a range from about 0.190 to equal to or less than about 0.230, such as in a range from about 0.200 to about 0.228, in a range from about 0.210 to about 0.223, or in a range from about 0.215 to about 0.220, including endpoints of the ranges, and all ranges and sub-ranges between the foregoing values. The Poisson's ratio values recited in this disclosure refer to a value as measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.”

In various embodiments, the glass compositions have a strain temperature (strain point), regardless of fictive temperature, in a range from about 500° C. to about 850° C., such as in a range from about 530° C. to about 825° C., in a range from about 560° C. to about 800° C., including all ranges and sub-ranges between the foregoing values. The strain point was determined using the beam bending viscosity method of ASTM C598-93(2013).

In various embodiments, the glass compositions have an annealing temperature (annealing point), regardless of fictive temperature, in a range from about 550° C. to about 900° C., such as in a range from about 575° C. to about 880° C., in a range from about 600° C. to about 865° C., or in a range from about 615° C. to about 850° C., including all ranges and sub-ranges between the foregoing values. The annealing point was determined using the beam bending viscosity method of ASTM C598-93(2013).

In various embodiments, the glass compositions a softening temperature (softening point), regardless of fictive temperature, in a range from about 800° C. to about 1200° C., such as in a range from about 850° C. to about 1150° C., in a range from about 875° C. to about 1130° C., or in a range from about 895° C. to about 1120° C., including all ranges and sub-ranges between the foregoing values. The softening point was determined using the parallel plate viscosity method of ASTM C1351M-96(2012).

In various embodiments, the concentration of constituents (e.g., SiO2, A1203, B₂O₃, SrO, and the like) are given in mole percent (mol %) on an oxide basis, unless otherwise specified. Constituents of the glasses according to embodiments are discussed individually below. Any of the variously recited ranges of one constituent may be individually combined with any of the variously recited ranges for any other constituent.

In various embodiments, an aluminosilicate or boroaluminosilicate glass composition with phosphorus pentoxide (P₂O₅) is provided. In some embodiments, the glass composition includes silica dioxide (SiO₂) (“silica”), aluminum oxide (Al₂O₃) (“alumina”), and phosphorus pentoxide (P₂O₅) (“phosphorus”). In some embodiments, the glass composition includes silica, alumina, boron trioxide (B₂O₃), and phosphorus. The glass composition also includes one or more alkali oxides and/or one or more alkaline earth metal oxides. In some embodiments, for example, the glass composition includes potassium oxide (K₂O), strontium oxide (SrO), barium oxide (BaO), or any combination thereof.

In various embodiments, the glass composition includes silica dioxide (SiO₂). Silica dioxide is the largest single component in the glass compositions. The SiO₂ concentration plays a role in controlling the stability and viscosity of the glass. High SiO₂ concentrations raise the viscosity of the glass, making melting of the glass difficult. The high viscosity of high SiO₂-containing glasses frustrates mixing, dissolution of batch materials, and bubbles rise during fining. High SiO₂ concentrations also require very high temperatures to maintain adequate flow and glass quality. Accordingly, the SiO₂ concentration in the glass should preferably not exceed about 75 mol %. As the SiO₂ concentration in the glass decreases below about 60 mol %, the liquidus temperature increases. As the liquidus temperature increases, the liquidus viscosity (the viscosity of the molten glass at the liquidus temperature) of the glass decreases. While the presence of B₂O₃ suppresses the liquidus temperature, the SiO₂ content should preferably be maintained at greater than about 50 mol % to prevent the glass from having excessively high liquidus temperature and low liquidus viscosity. In order to keep the liquidus viscosity from becoming too low or too high, the SiO₂ concentration may be included in an amount ranging from about 50 mol % to about 75 mol %. The SiO₂ concentration also provides the glass with chemical durability with respect to mineral acids, with the exception of hydrofluoric acid (HF). Accordingly, the SiO₂ concentration in the glasses described herein should be greater than 50 mol % in order to provide sufficient durability. In some embodiments, the glass composition includes about 50 mol % to about 80 mol % of SiO₂, or about 55 mol % to about 72 mol % of SiO₂, or about 55 to about 69 mol % of SiO₂. Preferably, the concentration of SiO₂ be within the range between about 50 mol % and about 72 mol %, between about 58 mol % and about 72 mol % in some embodiments, and between about 60 mol % and about 72 mol % in other embodiments.

In various embodiments, the glass composition includes aluminum oxide (Al₂O₃). Like SiO₂, Al₂O₃ may serve as a glass network former. Al₂O₃ can increase the viscosity of the glass due to its tetrahedral coordination in a glass melt formed from a glass composition, thereby decreasing the formability of the glass composition if the amount of Al₂O₃ is too high. However, when the concentration of Al₂O₃ is balanced against the concentration of SiO₂ in the glass composition, Al₂O₃ can reduce the liquidus temperature of the glass melt, thereby enhancing the liquidus viscosity and improving the compatibility of the glass composition with certain forming processes, such as the fusion forming process. In some embodiments, aluminum oxide may be included in an amount ranging from about 1 mol % to about 30 mol %. In some embodiments, the glass composition includes about 5 mol % to about 20 mol % of Al₂O₃, or about 9 mol % to about 18 mol % of Al₂O₃, or about 9 mol % to about 15 mol % of Al₂O₃.

In various embodiments, the glass composition includes phosphorus pentoxide (P₂O₅). Phosphorus pentoxide tends to reduce the dependence of various glass properties relative to the fictive temperature. For example, by reducing the specific volume relative to fictive temperature, the glass may exhibit less dimensional change through thermal cycling, which can result in improved compaction. A glass having a low specific volume dependence on fictive temperature would be a better substrate for micro-circuitry and display applications. However, P₂O₅ can adversely affect the chemical homogeneity of a glass composition and cause phase separation, particularly when P₂O₅ is included in larger concentrations. Typically, when the concentration of P₂O₅ is greater than about 10 mol % to about 15 mol %, the resulting glass may become hazy or cloudy. In some embodiments, P₂O₅ may be included in an amount ranging from about 1 mol % to about 15 mol %. In some embodiments, the glass composition includes about 1 mol % to about 10.5 mol % of silica dioxide, or about 5 mol % to about 15 mol % of P₂O₅, or about 9 mol % to about 15 mol % of P₂O₅.

In some embodiments, the glass composition includes boron trioxide (B₂O₃). Generally, boron trioxide is added to glass to reduce the melting temperature, decrease the liquidus temperature, increase the liquidus viscosity, and to improve mechanical durability relative to a glass containing no B₂O₃. Boron trioxide may be included in an amount ranging from 0 mol % to about 25 mol %. In some embodiments, the glass composition includes 0 mol % to about 20 mol % of B₂O₃, or about 5 mol % to about 20 mol % of B₂O₃, or about 10 mol % to about 20 mol % of B₂O₃. In some embodiments, the glass composition is free, or substantially free, of B₂O₃.

In some embodiments, the glass composition includes potassium oxide (K₂O). Potassium oxide can be used to reduce the property dependence on fictive temperature. Potassium oxide can also be advantageous for reducing the liquidus temperature of the composition. Potassium oxide may be included in an amount ranging from 0 mol % to about 15 mol %. In some embodiments, the glass composition includes 0 mol % to about 12 mol % of K₂O, or about 5 mol % to about 12 mol % of K₂O, or about 7 mol % to about 10 mol % of K₂O. In some embodiments, the glass composition is free, or substantially free, of K₂O.

In some embodiments, the glass composition includes strontium oxide (SrO). Strontium oxide may be included in an amount ranging from 0 mol % to about 15 mol %. In some embodiments, the glass composition includes about 0.5 mol % to about 12 mol % of SrO, or about 5 to about 12 mol % of SrO, or about 7 mol % to about 12 mol % of SrO. In some embodiments, the glass composition is free, or substantially free, of SrO.

In some embodiments, the glass composition includes barium oxide (BaO). Barium oxide may be included in an amount ranging from 0 to about 20 mol %. In some embodiments, the glass composition includes about 0.01 mol % to about 16 mol % of BaO, or about 0.02 mol % to about 12 mol % of BaO, or about 4 mol % to about 10 mol % of BaO. In some embodiments, the glass composition is free, or substantially free, of BaO.

In some embodiments, the glass composition includes zinc oxide (ZnO). Zinc oxide may be included in an amount ranging from 0 to about 5 mol %. In some embodiments, the glass composition includes about 0.01 mol % to about 3 mol % of ZnO, or about 0.1 mol % to about 2 mol % of ZnO, or about 2 mol % to about 3 mol % of ZnO. In some embodiments, the glass composition is free, or substantially free, of ZnO.

In some embodiments, the glass composition includes tin (stannic) oxide (SnO₂). Tin oxide is a fining agent that helps remove bubbles from glass compositions. Tin oxide may be included in an amount ranging from 0 to about 1 mol %. In some embodiments, the glass composition includes about 0.01 mol % to about 0.75 mol % of SnO₂, or about 0.03 mol % to about 0.3 mol % of SnO₂, or about 0.2 mol % to about 0.3 mol % of SnO₂. In some embodiments, the glass composition is free, or substantially free, of SnO₂.

In some embodiments, the glass composition specifically excludes certain modifiers. For example, in some embodiments, the glass composition is free, or substantially free, of lithium or sodium ions (e.g., Li₂O, Na₂O).

In some embodiments, the glass is transparent. In some embodiments, the glass composition includes a relatively small amount of high field strength modifiers, such as zinc oxide (ZnO), magnesium oxide (MgO), and calcium oxide (CaO). In some embodiments, the glass composition includes low field strength alkali ions, such as Rb and Cs, or other modifiers, or zirconium oxide (ZrO₂), in order to adjust the coefficient of thermal expansion, glass transition temperature, strength, or clarity.

In some embodiments, the glass comprises, in mole percent: about 40 to about 80 percent SiO₂; about 1 to about 30 percent Al₂O₃; 0 to about 30 percent B₂O₃; about 1.0 to about 10.1 percent P₂O₅; 0 to about 15 percent K₂O; 0 to about 1 percent MgO; 0 to about 1 percent CaO; 0 to about 20 percent SrO; 0 to about 20 percent BaO; 0 to about 5 percent ZnO; and 0 to about 1 percent SnO₂; wherein the sum of K₂O+SrO+BaO is in the range from about 10.5 percent to about 15.7 percent, and the sum of ZnO+MgO+CaO is less than about 5 percent.

In some embodiments, the glass comprises, in mole percent: about 55 to about 69 percent SiO₂; about 5 to about 20 percent Al₂O₃; 0 percent B₂O₃; about 1.0 to about 10 percent P₂O₅; 0 to about 15 percent K₂O; 0 to about 1 percent MgO; 0 to about 1 percent CaO; about 1 to about 17 percent SrO; 0 to about 20 percent BaO; 0 to about 3 percent ZnO; and 0 to about 1 percent SnO₂; wherein the sum of K₂O+SrO+BaO is in a range of about 10.5 percent to about 15.7 percent, and the sum of ZnO+MgO+CaO is less than 5 percent based.

The glass article may be characterized by the way it is formed. In some embodiments, the glass is down-drawable, wherein the glass is capable of being formed into sheets using down-draw methods such as, but not limited to, fusion draw and slot draw methods that are known to those skilled in the glass fabrication arts. Such down-draw processes are used in the large-scale manufacture of ion-exchangeable flat glass. In some embodiments, the glass may be characterized as float-formable, wherein the glass is formed by a float process.

The fusion draw process uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank. These outside surfaces extend down and inwardly so that they join at an edge below the drawing tank. The two flowing glass surfaces join at this edge to fuse and form a single flowing sheet. The fusion draw method offers the advantage that, since the two glass films flowing over the channel fuse together, neither outside surface of the resulting glass sheet comes in contact with any part of the apparatus. Thus, the surface properties are not affected by such contact.

The slot draw method is distinct from the fusion draw method. Here the molten raw material glass is provided to a drawing tank. The bottom of the drawing tank has an open slot with a nozzle that extends the length of the slot. The molten glass flows through the slot/nozzle and is drawn downward as a continuous sheet therethrough and into an annealing region. Compared to the fusion draw process, the slot draw process provides a thinner sheet, as only a single sheet is drawn through the slot, rather than two sheets being fused together, as in the fusion down-draw process.

In some embodiments, the glass is in the form of a sheet. According to various embodiments described herein, the glass substrate can be incorporated into a device in the form of a sheet. Various devices include, for example, flat panel displays, computer monitors, medical monitors, televisions, billboards, lights for interior or exterior illumination and/or signaling, heads-up displays, fully or partially transparent displays, flexible displays, laser printers, telephones, mobile phones, tablets, phablets, personal digital assistants (PDAs), wearable devices, laptop computers, digital cameras, camcorders, viewfinders, micro-displays, 3-D displays, virtual reality or augmented reality displays, vehicles, video walls comprising multiple displays tiled together, theater or stadium screen, and a sign.

### EXAMPLES

Various embodiments will be further clarified by the following examples. The following examples are set forth below to illustrate the methods and results according to the disclosed subject matter. These examples are not intended to be inclusive of all embodiments of the subject matter disclosed herein, but rather to illustrate representative methods and results. These examples are not intended to exclude equivalents and variations of the present disclosure which are apparent to one skilled in the art.

Efforts have been made to ensure accuracy with respect to numbers (e.g., amounts, temperature, etc.) but some errors and deviations should be accounted for. Unless indicated otherwise, temperature is in ° C. and is at or near ambient temperature, and pressure is at or near atmospheric. The compositions themselves are given in mole (mol %) percent on an oxide basis and have been normalized to 100%. There are numerous variations and combinations of reaction conditions, e.g., component concentrations, temperatures, pressures, and other reaction ranges or conditions that can be used to optimize the product purity and yield obtained from the described process. Only reasonable and routine experimentation will be required to optimize such process conditions.

The glass properties set forth in the tables were determined in accordance with techniques conventional in the glass art. Thus, the linear coefficient of thermal expansion (CTE) over the temperature range 25-300° C. is expressed in terms of x 10⁻⁷/° C. and the annealing point is expressed in terms of ° C. These values may be determined using fiber elongation techniques (e.g., ASTM E228-85 and ASTM C336). The density in terms of grams/cm³ (g/cm³) may be measured using the Archimedes method (ASTM C693). The melting temperature in terms of ° C. (defined as the temperature at which the glass melt demonstrates a viscosity of 200 poises) was calculated employing a Fulcher equation fit to high temperature viscosity data measured via rotating cylinders viscometry (ASTM C965-81).

The liquidus temperature of the glass in terms of ° C. was measured using the standard gradient boat liquidus method of ASTM C829-81. This involves placing crushed glass particles in a platinum boat, placing the boat in a furnace having a region of gradient temperatures, heating the boat in an appropriate temperature region for 24 hours, and determining by means of microscopic examination the highest temperature at which crystals appear in the interior of the glass. More particularly, the glass sample is removed from the Pt boat in one piece, and examined using polarized light microscopy to identify the location and nature of crystals which have formed against the Pt and air interfaces, and in the interior of the sample. Because the gradient of the furnace is very well known, temperature vs. location can be well estimated, within 5-10° C. The temperature at which crystals are observed in the internal portion of the sample is taken to represent the liquidus of the glass (for the corresponding test period). Testing is sometimes carried out at longer times (e.g. 72 hours), to observe slower growing phases. The liquidus viscosity in poises was determined from the liquidus temperature and the coefficients of the Fulcher equation.

Young's modulus values in terms of GPa were determined using a resonant ultrasonic spectroscopy (RUS) technique, such as the general type in ASTM E1875-00e1.

Raw materials were mixed together in a melting crucible according to the various compositions specified in Tables 1A-1D. The raw material mix was then heated in a furnace to a temperature allowing complete melting of the raw material. After the melting and homogenization of the composition, the glass was cast into samples and annealed in an annealing furnace.

TABLE 1A

| Mol % | 1 | 2 | 3 | 4 | 5 | 6 | 7 |
|---|---|---|---|---|---|---|---|
| SiO₂ | 66.61 | 61.83 | 61.66 | 65.12 | 58.59 | 60.08 | 61.90 |
| Al₂O₃ | 15.15 | 17.61 | 17.41 | 14.56 | 17.94 | 17.01 | 10.63 |
| P₂O₅ | 5.22 | 7.68 | 10.07 | 4.75 | 7.68 | 9.56 | 1.97 |
| B₂O₃ | 0.00 | 0.00 | 0.00 | 0.00 | 0.00 | 0.00 | 14.96 |
| K₂O | 0.00 | 0.00 | 0.00 | 0.00 | 0.00 | 0.00 | 0.00 |
| MgO | 0.02 | 0.02 | 0.01 | 0.03 | 0.03 | 0.02 | 0.02 |
| CaO | 0.03 | 0.04 | 0.04 | 0.07 | 0.07 | 0.06 | 0.06 |
| SrO | 12.95 | 12.81 | 10.80 | 0.36 | 0.38 | 0.31 | 10.40 |
| BaO | 0.02 | 0.01 | 0.01 | 15.11 | 15.31 | 12.95 | 0.08 |
| ZnO | 0.00 | 0.00 | 0.00 | 0.00 | 0.00 | 0.00 | 0.00 |
| SnO₂ | 0.00 | 0.00 | 0.00 | 0.00 | 0.00 | 0.00 | 0.00 |
| K₂O + SrO + BaO | 12.96 | 12.83 | 10.81 | 15.47 | 15.69 | 13.26 | 10.47 |
| ZnO + MgO + CaO | 0.05 | 0.05 | 0.05 | 0.10 | 0.10 | 0.09 | 0.07 |

Properties of the Glass

| | | | | | | | |
|---|---|---|---|---|---|---|---|
| Density (g/cm3) | 2.613 | 2.608 | 2.521 | 2.856 | 2.845 | 2.712 | 2.505 |
| Strain Point (° C.) | 777 | 769 | 770 | 787 | 773 | 757 | 619 |
| Anneal Point (° C.) | 835 | 826 | 830 | 845 | 832 | 820 | 670 |
| Softening Point (° C.) | 1088.4 | 1066.5 | 1088.9 | 1093.8 | 1077 | 1090.5 | 921 |
| CTE × 10−7 (1/° C.) | 39 | 38.9 | 34.8 | 48.1 | 46.7 | 43.8 | 39.7 |

TABLE 1B

| Mol % | 8 | 9 | 10 | 11 | 12 | 13 | 14 | 15 |
|---|---|---|---|---|---|---|---|---|
| SiO₂ | 62.40 | 55.77 | 60.15 | 66.37 | 67.37 | 68.02 | 66.60 | 67.24 |
| Al₂O₃ | 11.60 | 10.89 | 11.10 | 10.23 | 10.18 | 10.20 | 9.15 | 9.19 |
| P₂O₅ | 2.21 | 2.15 | 2.00 | 1.00 | 1.03 | 1.03 | 2.04 | 2.09 |
| B₂O₃ | 12.33 | 18.99 | 15.60 | 11.40 | 10.36 | 9.60 | 11.23 | 10.36 |
| K₂O | 0.00 | 0.00 | 0.00 | 0.00 | 0.00 | 0.00 | 0.00 | 0.00 |
| MgO | 0.01 | 0.03 | 0.03 | 0.02 | 0.02 | 0.02 | 0.02 | 0.02 |
| CaO | 0.07 | 0.06 | 0.05 | 0.07 | 0.07 | 0.07 | 0.06 | 0.07 |
| SrO | 11.31 | 0.30 | 0.27 | 10.68 | 10.75 | 10.83 | 10.66 | 10.79 |
| BaO | 0.08 | 11.81 | 10.80 | 0.03 | 0.02 | 0.03 | 0.02 | 0.03 |
| ZnO | 0.00 | 0.00 | 0.00 | 0.00 | 0.00 | 0.00 | 0.00 | 0.00 |
| SnO₂ | 0.00 | 0.00 | 0.00 | 0.20 | 0.20 | 0.21 | 0.20 | 0.21 |
| K₂O + SrO + BaO | 11.39 | 12.11 | 11.08 | 10.71 | 10.77 | 10.86 | 10.69 | 10.82 |
| ZnO + MgO + CaO | 0.08 | 0.08 | 0.08 | 0.09 | 0.09 | 0.09 | 0.08 | 0.09 |

Properties of the Glass

| | | | | | | | | |
|---|---|---|---|---|---|---|---|---|
| Density (g/cm3) | 2.524 | 2.612 | 2.638 | 2.572 | 2.532 | 2.539 | 2.514 | 2.522 |
| Strain Point (° C.) | 634 | 568 | 593 | 647 | 650 | 660 | 633 | 640 |
| Anneal Point (° C.) | 689 | 619 | 645 | 702 | 707 | 717 | 687 | 696 |
| Softening Point (° C.) | 950.8 | 898.3 | 907.2 | 958.6 | 966.1 | 974.1 | 947.5 | 957.4 |
| CTE × 10−7 (1/° C.) | 39.3 | 43.8 | 43.7 | 38.9 | 38.6 | 38.7 | 39.1 | 39.4 |

TABLE 1C

| Mol % | 16 | 17 | 18 | 19 | 20 | 21 | 22 |
|---|---|---|---|---|---|---|---|
| SiO₂ | 68.45 | 60.76 | 61.02 | 61.14 | 61.04 | 61.07 | 61.10 |
| Al₂O₃ | 9.08 | 17.40 | 17.35 | 17.40 | 17.43 | 17.49 | 17.53 |
| P₂O₅ | 2.07 | 7.53 | 7.45 | 7.35 | 7.39 | 7.33 | 7.30 |
| B₂O₃ | 9.32 | 0.00 | 0.00 | 0.00 | 0.00 | 0.00 | 0.00 |
| K₂O | 0.00 | 0.01 | 2.36 | 4.64 | 6.99 | 9.28 | 11.61 |
| MgO | 0.02 | 0.02 | 0.03 | 0.02 | 0.02 | 0.03 | 0.03 |
| CaO | 0.07 | 0.00 | 0.00 | 0.00 | 0.00 | 0.00 | 0.00 |
| SrO | 10.77 | 14.26 | 11.77 | 9.42 | 7.10 | 4.77 | 2.40 |
| BaO | 0.03 | 0.00 | 0.00 | 0.00 | 0.00 | 0.00 | 0.00 |
| ZnO | 0.00 | 0.00 | 0.00 | 0.00 | 0.00 | 0.00 | 0.00 |
| SnO₂ | 0.21 | 0.02 | 0.02 | 0.03 | 0.03 | 0.03 | 0.03 |
| K₂O + SrO + BaO | 10.79 | 14.27 | 14.13 | 14.06 | 14.09 | 14.05 | 14.01 |
| ZnO + MgO + CaO | 0.08 | 0.02 | 0.03 | 0.02 | 0.02 | 0.03 | 0.03 |

Properties of the Glass

| | | | | | | | |
|---|---|---|---|---|---|---|---|
| Density (g/cm3) | 2.525 | 2.655 | 2.594 | 2.54 | 2.491 | 2.446 | 2.403 |
| Strain Point (° C.) | 647 | 771.4 | 751.8 | 747.3 | 739.2 | 733.5 | 735.2 |
| Anneal Point (° C.) | 703 | 821.8 | 806.5 | 803.5 | 796.8 | 795.6 | 800.7 |
| Softening Point (° C.) | 966 | 1057 | 1057 | 1065.9 | 1078.4 | 1092.3 | 1116.9 |
| CTE × 10−7 (1/° C.) | 39.2 | | | | | | |

TABLE 1D

| Mol % | 23 | 24 | 25 | 26 | 27 | 28 | 29 | 30 |
|---|---|---|---|---|---|---|---|---|
| SiO₂ | 60.53 | 60.66 | 61.01 | 60.88 | 60.91 | 60.96 | 63.75 | 63.93 |
| Al₂O₃ | 17.33 | 17.39 | 17.40 | 17.47 | 17.55 | 17.53 | 13.89 | 13.88 |
| P₂O₅ | 7.14 | 7.19 | 7.14 | 7.23 | 7.26 | 7.32 | 7.59 | 7.51 |
| B₂O₃ | 0.00 | 0.00 | 0.00 | 0.00 | 0.00 | 0.00 | 0.00 | 0.00 |
| K₂O | 0.01 | 2.31 | 4.53 | 6.94 | 9.27 | 11.63 | 0.01 | 2.28 |
| MgO | 0.02 | 0.02 | 0.02 | 0.02 | 0.02 | 0.03 | 0.00 | 0.00 |
| CaO | 0.00 | 0.00 | 0.00 | 0.00 | 0.00 | 0.00 | 0.06 | 0.05 |
| SrO | 0.45 | 0.38 | 0.30 | 0.22 | 0.15 | 0.08 | 12.20 | 9.86 |
| BaO | 14.49 | 12.02 | 9.57 | 7.21 | 4.81 | 2.42 | 0.00 | 0.00 |
| ZnO | 0.00 | 0.00 | 0.00 | 0.00 | 0.00 | 0.00 | 2.48 | 2.46 |
| SnO₂ | 0.03 | 0.03 | 0.03 | 0.03 | 0.03 | 0.03 | 0.03 | 0.03 |
| K₂O + SrO + BaO | 14.95 | 14.71 | 14.40 | 14.37 | 14.23 | 14.13 | 12.20 | 12.14 |
| ZnO + MgO + CaO | 0.02 | 0.02 | 0.02 | 0.02 | 0.02 | 0.03 | 2.53 | 2.51 |

Properties of the Glass

| | | | | | | | | |
|---|---|---|---|---|---|---|---|---|
| Density (g/cm3) | 2.831 | 2.742 | 2.661 | 2.583 | 2.508 | 2.422 | | 2.58 |
| Strain Point (° C.) | 778.2 | 756.3 | 748.2 | 736.1 | 729.4 | 729.8 | 726.6 | 711.5 |
| Anneal Point (° C.) | 832.1 | 814.3 | 807.1 | 796 | 793.4 | 796.2 | 776.4 | 765.3 |
| Softening Point (° C.) | 1084.5 | 1079.6 | 1084.9 | 1090 | 1102 | 1118 | 1026 | |
| CTE × 10−7 (1/° C.) | | | | | | | | |

As shown in Tables 1A-1D, glass compositions 1-30 include SiO₂ in an amount ranging from about 50 to about 80 mole percent, Al₂O₃ in an amount ranging from about 1 to about 30 mole percent, B₂O₃ in an amount ranging from 0 to about 25 mole percent, and P₂O₅ in an amount ranging from about 1 to about 15 mole percent, the sum of K₂O+SrO+BaO is in a range from about 10.5 to about 15.7 mole percent, and the sum of ZnO+MgO+CaO is less than 5 mole percent. Each of the glass compositions have, regardless of fictive temperature, a density in a range from about 2.00 g/cm³ to about 3.30 g/cm³, a strain temperature (strain point) in a range from about 500° C. to about 850° C., an annealing temperature (annealing point) in a range from about 550° C. to about 900° C., and a softening temperature (softening point) in a range from about 800° C. to about 1200° C.

Further property data is provided for Compositions 17-21 (Table 2A) and 23-28 (Table 2B). In particular, the properties of each glass substrate as a function of fictive temperature are provided. Based on such properties, the Young's modulus slope as a function of fictive temperature at strain and anneal points was determined for each of the substrates.

TABLE 2A

| | | | | |
|---|---|---|---|---|
| 17 | 18 | 19 | 20 | 21 |

Properties as a function of fictive temperature

| | | | | | |
|---|---|---|---|---|---|
| Time (hr) | 184 | 312 | 312 | 312 | 184 |
| Temperature (° C., | 771 | 752 | 747 | 737 | 734 |
| Approximate Strain | | | | | |
| Point) | | | | | |
| # of RUS measurements | 20 | 19 | 15 | 17 | 20 |
| Poisson's Ratio | 0.221 | 0.215 | 0.209 | 0.202 | 0.200 |
| E (Young's Modulus, | 73.7 | 71.1 | 68.5 | 66.0 | 63.5 |
| GPa) | | | | | |
| G (Shear Modulus, GPa) | 30.2 | 29.3 | 28.3 | 27.4 | 26.4 |
| Time (hr) | 47 | 69 | 46 | 47 | 47 |
| Temperature (° C., | 822 | 806 | 804 | 797 | 796 |
| Approximate Anneal | | | | | |
| Point) | | | | | |
| # of RUS measurements | 20 | 19 | 14 | 18 | 20 |
| Poisson's Ratio | 0.220 | 0.214 | 0.211 | 0.205 | 0.200 |
| E (Young's Modulus, | 72.8 | 70.2 | 67.8 | 65.3 | 62.8 |
| GPa) | | | | | |
| G (Shear Modulus, GPa) | 29.8 | 28.9 | 28.0 | 27.1 | 26.1 |

Young's modulus slope as a function of fictive temperature
at strain and anneal points

| | | | | | |
|---|---|---|---|---|---|
| Slope dE/dT_{f} (GPa/° C.), | −0.018 | −0.017 | −0.012 | −0.011 | −0.011 |
| where dE is (E_{anneal pt} − | | | | | |
| E_{strain pt})/(T_{anneal pt} − | | | | | |
| T_{strain pt}) | | | | | |
| Slope dE/dT_{f} (GPa/° | 0.002 | 0.001 | 0.002 | 0.002 | 0.002 |
| C.) − 1 stdev | | | | | |

TABLE 2B

| | | | | | |
|---|---|---|---|---|---|
| 23 | 24 | 25 | 26 | 27 | 28 |

Properties as a function of fictive temperature

| | | | | | | |
|---|---|---|---|---|---|---|
| Time (hr) | 168 | 264 | 198 | 288 | 244 | 168 |
| Temperature (° C., Approximate | 778 | 755 | 749 | 739 | 729 | 730 |
| Strain Point) | | | | | | |
| # of RUS measurements | 20 | 20 | 20 | 20 | 17 | 19 |
| Poisson's Ratio | 0.220 | 0.217 | 0.213 | 0.211 | 0.207 | 0.200 |
| E (Young's Modulus, GPa) | 69.0 | 67.7 | 66.1 | 64.2 | 62.4 | 60.2 |
| G (Shear Modulus, GPa) | 28.3 | 27.8 | 27.2 | 26.5 | 25.9 | 25.1 |
| Time (hr) | 56 | 56 | 209 | 48 | 190 | 53 |
| Temperature (° C., Approximate | 832 | 814 | 807 | 796 | 795 | 796 |
| Anneal Point) | | | | | | |
| # of RUS measurements | 19 | 20 | 20 | 15 | 20 | 14 |
| Poisson's Ratio | 0.220 | 0.217 | 0.214 | 0.211 | 0.206 | 0.201 |
| E (Young's Modulus, GPa) | 68.1 | 66.9 | 65.5 | 64.1 | 61.7 | 59.6 |
| G (Shear Modulus, GPa) | 27.9 | 27.5 | 27.0 | 26.4 | 25.6 | 24.8 |

Young's modulus slope as a function of fictive temperature
at strain and anneal points

| | | | | | | |
|---|---|---|---|---|---|---|
| Slope dE/dT_{f} (GPa/° C.), where | −0.016 | −0.014 | −0.010 | −0.002 | −0.010 | −0.009 |
| dE is (E_{anneal pt} − E_{strain pt})/ | | | | | | |
| (T_{anneal pt} − T_{strain pt}) | | | | | | |
| Slope dE/dT_{f} (GPa/° C.) − 1 stdev | 0.001 | 0.001 | 0.002 | 0.002 | 0.002 | 0.001 |

Each of the glass composition examples in Tables 2A and 2B have, regardless of fictive temperature, a Young's modulus in a range from about 50.0 GPa to about 80.0 GPa, and a Poisson's ratio in a range from about 0.190 to equal to or less than about 0.230. Further, each of the examples in Tables 2A and 2B yielded a glass with the slope of a line extending from the first endpoint to the second endpoint—as defined above and listed in Tables 1A-1D as “Slope dE/dT_{f} (GPa/° C.)—of less than |0.022| GPa/° C., demonstrating that glasses comprising about 1.0 to about 10.1 mole percent P₂O₅ and about 10.5 to about 15.7 mole percent of SrO, BaO, and K₂O (combined) exhibit a relatively low Young's modulus slopes versus fictive temperature. These results unexpectedly indicate a low specific volume dependence on fictive temperature. Accordingly, the glass compositions are suitable substrates for various electronic devices.

The foregoing is provided for purposes of illustrating, explaining, and describing embodiments of this application. Modifications and adaptations to these embodiments will be apparent to those skilled in the art and may be made without departing from the scope or spirit of this application. All such modifications are intended to be encompassed within the below claims.

Although the subject matter has been described in terms of exemplary embodiments, it is not limited thereto. Rather, the appended claims should be construed broadly, to include other variants and embodiments, which may be made by those skilled in the art.

What is claimed is:

1. A glass substrate, comprising, in mole percent:
about 40 to about 80 percent SiO₂;
about 1 to about 30 percent Al₂O₃;
0 to about 30 percent B₂O₃;
about 1.0 to about 10.1 percent P₂O₅; and
about 10.5 to about 15.7 percent of SrO, BaO, K₂O, or combination thereof;
wherein the glass substrate includes less than about 5 percent of ZnO, MgO, CaO, or a combination thereof.

2. The glass substrate of claim 1, comprising less than about 3 percent of ZnO, MgO, CaO, or a combination thereof.

3. The glass substrate of claim 1, comprising less than about 1 percent of ZnO, MgO, CaO, or a combination thereof.

4. The glass substrate of claim 1, comprising:
about 50 to about 72 percent SiO₂;
about 5 to about 25 percent Al₂O₃; and
about 5 to about 25 percent B₂O₃.

5. The glass substrate of claim 4, comprising about 5.0 to about 10.0 percent P₂O₅.

6. The glass substrate of claim 4, comprising about 6.5 to about 8.5 percent P₂O₅.

7. The glass substrate of claim 1, further comprising SnO₂.

8. The glass substrate of claim 1, wherein an absolute value of a slope dE/dT_{f} of a line extending between a first endpoint and a second endpoint is less than or equal to |0.022| GPa/° C.,
wherein the first endpoint is a Young's modulus of the glass substrate at a fictive temperature of an annealing point temperature of the glass substrate and the second endpoint is a Young's modulus of the glass substrate at a fictive temperature of a strain point temperature of the glass substrate.

9. The glass substrate of claim 8, wherein the absolute value of a slope dE/dT_{f} is in a range from about |0.001| GPa/° C. to about |0.022| GPa/° C.

10. A glass substrate, comprising, in mole percent:
40 to about 80 percent SiO₂;
about 1 to about 30 percent Al₂O₃;
0 to about 30 percent B₂O₃;
about 1.0 to about 10.1 percent P₂O₅;
0 to about 15 percent K₂O;
0 to about 1 percent MgO;
0 to about 1 percent CaO;
0 to about 20 percent SrO;
0 to about 20 percent BaO;
0 to about 5 percent ZnO; and
0 to about 1 percent SnO₂;
wherein the sum of K₂O+SrO+BaO is in a range from about 10.5 to about 15.7 percent; and wherein the sum of ZnO+MgO+CaO is less than about 5 percent.

11. The glass substrate of claim 10, comprising, in mole percent:
about 50 to about 72 percent SiO₂;
about 5 to about 20 percent Al₂O₃;
0 to about 20 percent B₂O₃;
about 1.0 to about 10 percent P₂O₅;
0 to about 15 percent K₂O;
0 to about 1 percent MgO;
0 to about 1 percent CaO;
0 to about 17 percent SrO;
0 to about 20 percent BaO;
0 to about 3 percent ZnO; and
0 to about 1 percent SnO₂;
wherein the sum of K₂O+SrO+BaO is in a range from about 10.5 to about 15.7 percent; and wherein the sum of ZnO+MgO+CaO is less than about 5 percent.

12. The glass substrate of claim 10, comprising, in mole percent:
about 55 to about 72 percent SiO₂;
about 5 to about 20 percent Al₂O₃;
0 percent B₂O₃;
about 1.0 to about 10 percent P₂O₅;
0 to about 15 percent K₂O;
0 to about 1 percent MgO;
0 to about 1 percent CaO;
about 0.1 to about 17 percent SrO;
0 to about 20 percent BaO;
0 to about 3 percent ZnO; and
0 to about 1 percent SnO₂;
wherein the sum of K₂O+SrO+BaO is in a range from about 10.5 to about 15.7 percent; and wherein the sum of ZnO+MgO+CaO is less than about 5 percent.

13. The glass substrate of claim 10, comprising, in mole percent:
about 55 to about 69 percent SiO₂;
about 5 to about 20 percent Al₂O₃;
0 percent B₂O₃;
about 1.0 to about 10 percent P₂O₅;
0 to about 15 percent K₂O;
0 to about 1 percent MgO;
0 to about 1 percent CaO;
about 1 to about 17 percent SrO;
0 to about 20 percent BaO;
0 to about 3 percent ZnO; and
0 to about 1 percent SnO₂;
wherein the sum of K₂O+SrO+BaO is in a range from about 10.5 to about 15.7 percent; and wherein the sum of ZnO+MgO+CaO is less than about 5 percent.

14. The glass substrate of claim 10, wherein an absolute value of a slope dE/dT_{f} of a line extending between a first endpoint and a second endpoint is less than or equal to |0.022| GPa/° C.,
wherein the first endpoint is a Young's modulus of the glass substrate at a fictive temperature of an annealing point temperature of the glass substrate and the second endpoint is a Young's modulus of the glass substrate at a fictive temperature of a strain point temperature of the glass substrate.

15. The glass substrate of claim 14, wherein the absolute value of a slope dE/dT_{f} is in a range from about |0.001| GPa/° C. to about |0.022| GPa/° C.

16. The glass substrate of claim 14, wherein the absolute value of a slope dE/dT_{f} is in a range from about |0.002| GPa/° C. to about |0.018| GPa/° C.

17. A device comprising the glass substrate of claim 1.

18. The device of claim 17, wherein the device is a flat panel display, computer monitor, medical monitor, television, billboard, light for interior or exterior illumination and/or signaling, heads-up display, fully or partially transparent display, flexible display, laser printer, telephone, mobile phone, tablet, phablet, personal digital assistant, wearable device, laptop computer, digital camera, camcorder, viewfinder, micro-display, 3-D display, virtual reality or augmented reality display, vehicle, video wall comprising multiple displays tiled together, theater or stadium screen, or a sign.

19. A device comprising the glass substrate of claim 10.

20. The device of claim 19, wherein the device is a flat panel display, computer monitor, medical monitor, television, billboard, light for interior or exterior illumination and/or signaling, heads-up display, fully or partially transparent display, flexible display, laser printer, telephone, mobile phone, tablet, phablet, personal digital assistant, wearable device, laptop computer, digital camera, camcorder, viewfinder, micro-display, 3-D display, virtual reality or augmented reality display, vehicle, video wall comprising multiple displays tiled together, theater or stadium screen, or a sign.
